(19) United States
(12) Patent Application Publication
(10) Pub. No.: US 2004/0203895 A1
(43) Pub. Date: Oct. 14, 2004

(54) Locking of communication device based on proximity

(76) Inventor: Senaka Balasuriya, Arlington Heights, IL (US)

Correspondence Address: MOTOROLA, INC., 1303 EAST ALGONQUIN ROAD, IL01/3RD, SCHAUMBURG, IL, 60196

(21) Appl. No.: 10/319,727

(22) Filed: Dec. 16, 2002

(51) Int. Cl. H04Q 7/20; H04M 1/00; H04B 1/38

(52) U.S. Cl. 455/456.1; 455/557

(57) ABSTRACT

A method of locking a communication device based on proximity includes a step of providing (202) a location device that is positioned on the person of an authorized user of the communication device. The communication device and the location device are initialized (204) to define proximity locking rules. Signals are transmitted (206) by the location device and detected (208) by the communication device to determine proximity (210). If the devices are found to not be in proximity to each other, at least one function of the communication device is locked (211) from use, to prevent unauthorized use of the communication device if it were to be lost or stolen.

### FIELD OF THE INVENTION

The present invention relates generally to monitoring the proximity of objects, and more particularly to the locking of communication devices by monitoring the proximity thereof.

### BACKGROUND OF THE INVENTION

Mobile communication devices, such as cellular radiotelephones are easily misplaced and stolen because of their small size and low weight. In such situations, unauthorized users can use the radiotelephone for their own purposes, with calls being charged to the person who lost the radiotelephone. It would be of benefit to prevent such unauthorized or fraudulent use of radiotelephones.

One prior art technique is provided in some radiotelephone that locks the phone out at power-up if a user cannot enter the proper authorization code or personal identification number (PIN). In addition, phones are also available that prevent unauthorized calls on a call-by-call basis. In each of these cases, the radiotelephone must be preprogrammed to provide these lockout mechanisms, and do not address the case where the phone is lost or stolen. In other words, there is no technique to lock out the phone once it has left the user's possession. Other related art provides mechanisms to activate a door or other security mechanism when a user comes close to it. However, this type of art does not provide the lockout flexibility needed with radiotelephones.

Another prior art solution is to use the Global Positioning System to provide location services. Although effective, the cost of the technology is prohibitive, and there is little need to locate a person or object anywhere on the globe. This is also true in the case of a lost phone. Another prior art solution has been to install radio frequency (RF) tags, such as in a car for example, which can transmit a location of the car if it is stolen. Again, the technology is expensive and requires a large transmitter power source, such as a car battery. In addition, special receivers and software are needed to detect the signal. Another prior art solution uses cellular technology to locate a control signal scan of a cellular device. However, this technique requires on-board emergency activation circuitry and a high power source for the continuous multicell control signal scan and response transmissions thereto. All of the above suffer from high expense, being impractical, or being difficulty to use.

It would be beneficial to restrict one or more functions of the device automatically, when the device leaves the proximity of the owner or user. For example, if the device is indeed stolen, it is beneficial to prevent outgoing calls from the device to curb unauthorized use. On the other hand, it is beneficial to activate or not prevent incoming calls to the device so that whoever finds the device can answer the call.

Therefore, there is a need for an improved monitoring communication system that autonomously monitors proximity of a person to a radiotelephone. In particular, what is needed is a system to provide a automatic partial deactivation mechanism based on a subscriber's, owner's, or authorized user's proximity to the communication device. It would also be an advantage to provide a mechanism that allows a user to selectively configure a device to lock itself up (and de-activate at least one function) when not in proximity with its current owner or subscribe or who's logged on at that time. This would be convenient as well as provide additional security. As a result, there is a need to selectively activate features automatically based on proximity.

### BRIEF DESCRIPTION OF THE DRAWINGS

FIG. 1 shows a simplified schematic diagram of a proximity monitoring communication system, in accordance with the present invention;

FIG. 2 shows a flow chart of a first embodiment of proximity monitoring, in accordance with the present invention;

FIG. 3 shows a flow chart of initialization of the communication system, in accordance with the present invention;

FIG. 4 shows a flow chart of a second embodiment of proximity monitoring, in accordance with the present invention;

FIG. 5 shows a flow chart of a transfer embodiment of proximity monitoring, in accordance with the present invention; and

FIG. 6 shows a flow chart of a suspend embodiment of proximity monitoring, in accordance with the present invention.

### DETAILED DESCRIPTION OF THE PREFERRED EMBODIMENTS

The present invention provides an improved monitoring communication system that autonomously monitors proximity between a person and a communication device such as a cellular radiotelephone. Proximal boundaries can be preset to automatically lockout the radiotelephone if the person is no longer in proximity. In particular, the present invention provides the automatic disabling of at least one feature of the communication device, such as preventing outgoing calls but not incoming calls, when the phone is no longer in proximity to the user. This is accomplished by providing a wireless location device to be worn or carried by the person, with a communication of the location device and the radiotelephone used to determine proximity. This present invention fulfills a need to lock a device in a novel way based on proximity by providing a convenient mechanism to activate and de-activate functions when the user/owner is no longer in the proximity of the device.

The present invention can advantageously be used in those wireless radio communication systems that utilize a local area network along with a wide area network. In particular, the proposed third generation (3G) radio communication systems specify different cell sizes defining wide area networks (megacell, macrocell) and local area networks (microcell, picocell). The present invention can be implemented on a very compact and cost effective way, which is desirable for small transceiver devices that are most effective in picocell local area networks, such as are defined for the Bluetooth™ system (Specification on the Bluetooth System, Ver. 1.1, Feb. 22, 2001), for example.

Preferably, the present invention allows a user to selectively configure a personal communication device such that when the user has moved away at least a predetermined distance for at least a predetermined period of time from at least one of the devices associated with the personal communication device, the personal communication device would de-activate at least one function (e.g. prevent outgoing calls). More preferably, the user can configure one or more of: (a) the particular function to activate or deactivate, (b) the distance of separation to activate such function, (c) the period of time that must elapse in order to activate or deactivate a chosen function, (d) the proximity monitoring technique, and (e) an optional time period for lockout.

In practice, a user would initialize the system to provide the necessary protections. For example, a user would first select at least one communication device to be locked out based on proximity. Next, the user would select at least one user (represented by a location device), who must be distanced/separated from the device to trigger the lockout action (e.g. self, family members, authorized friends, others, etc). Next, the user can select one or more functions to activate or de-activate. For example, this may be selected from a menu that lists features to activate or deactivate such as: out-going calls, games, phone book access, network access, e-mail, phone configuration, passwords, e-wallet & e-commerce applications stored in a memory, etc. Next, the user could select a minimal distance of separation to trigger the above action. Optionally, the user could select a minimal period of time of separation to trigger above action. Preferably, all of the above actions are performed on the communication device, but may be performed on another device and transferred to the communication device using synchronization technology, as is well known to persons having ordinary skills in the relevant art.

All of the above actions are subsequently triggered when the location device travels beyond the proximity of the communication device. One method of determining proximity between the user and the communication device is by the having the communication device periodically sending and/or receiving a signal from the location device. This location device would typically be worn by, implanted in, or otherwise attached to, the user so that proximity with the user can be determined effectively. For example, the location device can be a Bluetooth-enabled wristwatch worn by the user. Since it is inconvenient to have the location device attached to the user all the time, the communication device may be configured to selectively activate or de-activate only at certain times (e.g. 8 am to 10 pm).

The communication device would periodically send a signal to the identified location device, and if a response is not received within a predetermined number of tries and/or a predetermined time, the communication device would activate or deactivate at least one function associated with the communication device. For example, outgoing calls may be de-activated for a given period of time. Likewise, the location device can periodically send out signals, which, when not received by the communication device for a period of time, would cause the communication device to activate or de-activate at least one of its functions, such as outgoing calls. Preferably, the radiotelephone does not prevent outgoing calls to emergency numbers (e.g. E911) or other predetermined numbers.

Alternatively, the communication device sends a signal to the identified location device only when a user attempts to utilize a function associated with the communication device, for example, place an outgoing call, and if a response is not received within a predetermined number of tries and/or a predetermined time, the communication device would activate or de-activate at least one function associated with the communication device.

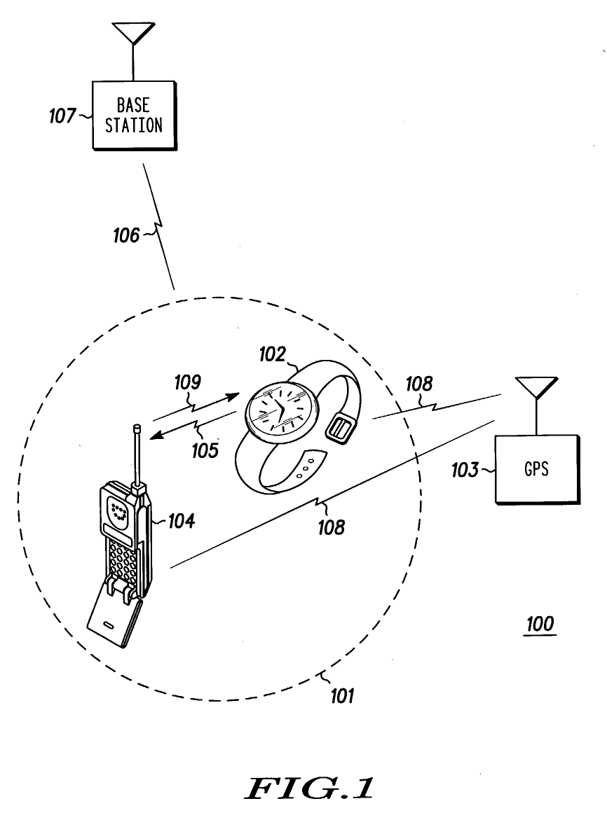

FIG. 1 illustrates a proximity monitoring communication system 100 for locking at least one function of a communication device. The system includes a wireless location device operable on a short-range wireless network 101 such as a wireless local area network, in accordance with the present invention. Preferably, the local area network is a Bluetooth™ piconet. The system 100 also includes a wireless communication device 104 operable on a wireless wide area network such as a cellular communication system (104,106,107) and the short-range wireless network 101 to communicate with the location device. It is envisioned that the location device 102 is worn as a bracelet, tag or other device located on the person of an authorized user of the communication device 104 such as a cellular phone. Preferably, the location device 102 is operable as a slave unit in the local area network 101. The location device 102 includes a unique identifier, which is already provided in devices operable under the Bluetooth™ standard. The wireless location device 102 transmits a signal 105 on the local area network 101.

In the simplest embodiment, the location device 102 includes a transmitter which broadcasts its identification code, signal or number to the wireless communication device 104. A communication manager within the communication device 104, is operable to detect the signal 105 from the location device to determine a proximity thereof. The communication manager can be software running on the main processor or DSP of the communication device or a separate hardware module controlling the local area network, for example. If the location device includes a transceiver for two-way communication, the communication manager can direct the communication device to periodically send a polling signal 109 to the location device, and the communication manager detects whether the location device sends a signal 105 responding to the poll within a predetermined number of polling attempts before locking the communication device. Transmitting and receiving (polling) can occur periodically. For example, the location signal 105 can be constant or preferably occurs periodically to save battery current. This signal can be polled at 1.28 ms intervals as is provided for in the standard. This polling rate can also be reduced to further save battery power if the strength of the received signal is constant for several minutes. Optionally, the communication manager compares Global Positioning System 103 location information 108 of the communication device 104 and the location device 102, to define a proximity therebetween. Other circuits are also incorporated in the location device and communication device for the proper operation as provided for in the Bluetooth™ standard. For the most part, these circuits will not be described herein as such details are not necessary to obtain a complete understanding of the present invention and are within the skills of persons having ordinary skills in the relevant art.

The wireless communication device 104 is operable as a master unit of the local area network 101. The communication manager of the wireless communication device 104 is operable to measure a strength of the received signal 105, or just the signal itself from the wireless location device 102. Preferably, the measure of strength is a received signal strength indicator (RSSI), as is known in the art, and defines a proximity between the communication device and location device. If a received signal is no longer detected, or if the signal strength is compared to a predetermined threshold and found to be less than the predetermined threshold, this would indicate that the wireless location device 102 is straying from the proximity (shown as dotted line 101) of the local area network.

When the communication manager detects that the location device 102 is no longer in proximity to the communication device 104, the communication manager determines at least one function to activate or deactivate and activates or deactivates that function of the communication device 104. Preferably, the communication manager waits a predetermined time, during which the signal indicates that the location device is no longer in proximity to the communication device, before locking the selected function of the communication device. If the location device returns to proximity of the communication device before the timeout then the function will not be locked out. Or if the function is locked out after timeout and the location device returns to proximity of the communication device then the function will be reactivated. Alternatively, the device can prompt a user to enter an authorization code to access the at least one locked function of the communication device, even if the communication device is not in proximity to the location device. In a preferred embodiment, the communication manager locks the function of outgoing calls from the communication device, with the exception of emergency calls.

The present invention also envisions the transfer of the location device between master units. In other words, a group of users can be authorized to use the same communication device. This can be accomplished by having the communication manger poll for the unique identifier for each of the location units of the authorized users, and responding to any authorized identifier in the local area network. For example, family members can be assign personalized identification fobs. A personal identification number (PIN) can be used to activate the communication device. This can be accomplished either automatically or manually.

Preferably, the wide area network signaling is performed on the paging channels of the compatible cellular telephone protocol. For example, such messaging can be accomplished on a Short Messages Service (SMS) channel in a GSM (Global System for Mobile communication), as is known in the art. In practice, all wide area network communication is carried out on a compatible cellular radiotelephone system and the at least one monitor device is operable on a Bluetooth™ piconet system. It is also envisioned that if a slave unit becomes lost a superuser can poll all the available piconets to determine if the slave unit is present in any of those cells.

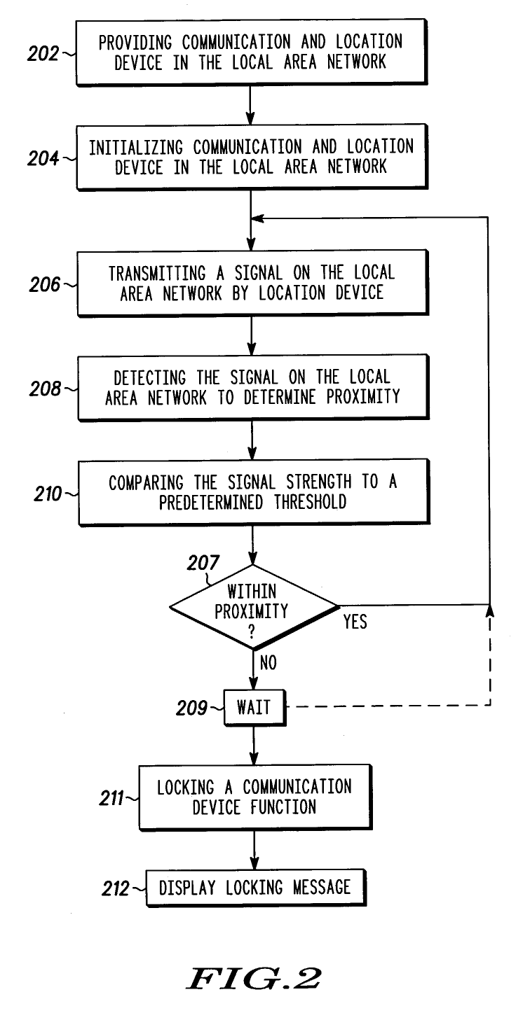

As shown in FIG. 2, the present invention provides a method of locking a communication device based on proximity. The method includes providing 202 a location device operable to communicate with the communication device (as represented in FIG. 1). The location device is located on the person of an authorized user of the communication device. The communication device is operable on a compatible wide area network, while supporting a separate short-range wireless link, such as a local area network to communication with the location device. Preferably, the communication device is operable on a compatible cellular radiotelephone system and the at least one monitor device is operable on a Bluetooth™ piconet system. A next step includes initializing 204 the communication device and the location device in the local area network. The initialization step can also include the owner of the communication device setting up the functions to be deactivated, the authorized users, and timeouts, as described previously.

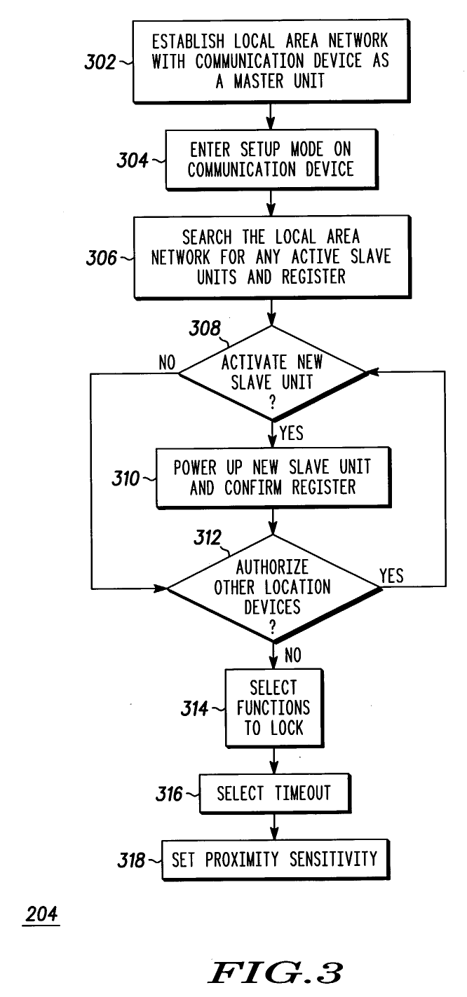

FIG. 3 shows a flow chart of the substeps of initializing 204. At the beginning, a communication device is turned on and would establish 302 a local area network with itself as the master unit. Preferably, a Bluetooth™ network is established. More preferably, the communication device has preprogrammed software that is operable in accordance with the present invention. In this way, the proximity monitoring function can be menu-selectable. When the proximity monitoring function is selected, the communication device enters a set-up mode 304. The master unit searches 306 the local area network for any active slave units that have been preprogrammed into communication device. In particular, slave units operable on the Bluetooth™ standard have unique identification numbers preprogrammed therein. This unique identifier for the location device can be entered in the communication device to control locking a function thereof.

If a new slave unit is to be authorized 308, the new slave unit can be powered up 310. After this, a menu on the master unit can be selected to run the set-up, registry, and authorization of new users, which can be done automatically by periodic polling for slave devices. In either case, the master unit can register the identification of the newly activated slave unit. Using text entry, a user can enter a name to associate with the new identification on the master unit. Preferably, the master unit can have pre-stored names associated with each programmed identification, e.g. a authorized user's name associated with a particular slave identification. In operation, the name can be shown on a display of the master unit when the slave unit is active on the local area network. As a check, the owner can turn off the registered slave unit to see if the master unit operates properly to note the dropping of the slave unit from the local area network. These steps can be repeated to add any number of slave units to the local area network.

In addition, menu selections can be presented to a user for selecting 314 at least one function of the communication device to be deactivated upon losing proximity of a slave unit from the local area network. Further, timeout period can be set 316 to delay locking a function of the communication device when the location device leaves the proximity thereof, as described previously. The signal strength sensitivity or threshold of the proximity monitoring can also be set 318 at this time to define a proximity for triggering function deactivation. This can also be menu-selected. As a default, the master unit(s) will deactivate the selected function if the slave unit drops off the local area network or a signal strength from the slave unit falls below a preset threshold. This default mode can be preset and would require no action on the part of the user of the master unit.

In operation, and referring back to FIG. 2 the next steps in the proximity monitoring process include transmitting 206 a signal on the local area network by the location (slave) device. A next step includes detecting 208 the signal, if any, on the local area network and preferably measuring the signal strength by the communication (master) device or communication manager therein followed by comparing 210 the strength to the threshold to define a proximity between the communication device and location device. This also includes detecting a “no signal” condition. The transmitting and detecting steps are repeated at periodic intervals. For example, the transmitting step includes periodically sending a polling signal to the location device, and the detecting step includes detecting whether the location device sends a signal responding to the poll within a predetermined number of polling attempts. In the Bluetooth™ system, repeated polling takes place at a nominal 1.28 ms period. Moreover, the Bluetooth system has a limit signal that can be used to define proximity. In the above embodiments, it is only necessary that the slave unit has transmit capabilities on the local area network. However, if the slave unit is provided with a transceiver, further functionality can be added, as described previously.

A next step 207 decides if the location device is proximate to the communication device. If the devices are proximate, then polling continues by returning to the transmitting 206 and detecting 208 steps. However, if the devices are no longer proximate, a next step includes locking 211 at least one function of the communication device when the detecting step indicates that the identified location device is no longer in proximity to the communication device, i.e. when the signal strength falls below the threshold. Preferably, before the locking step, waiting step 209 is included to wait a predetermined time, during which the signal indicates that the location device is no longer in proximity to the communication device, before locking the communication device. If the location device returns to proximity of the communication device, then the locking step can be aborted. In a preferred embodiment, the method includes a further step 212 of indicating a locking message on the communication device when the selected function of the communication device is locked. It is also understood that locking a function of the communication device includes preventing access to the function by disabling a user input mechanism such as the keyboard as well as activating or deactivating the function itself. The present invention also provides for unlocking the at least one function of the communication device when the detecting step indicates that the location device is within proximity to the communication device.

The present invention also provides for a second embodiment wherein at least one particular function is identified to be blocked if the location device is not in proximity to the communication device. Thereafter, when an attempt is made to access that particular function, the communication device searches for the location device to determine if it is in proximity to the communication device. If the location device is in proximity, then access to that function is allowed. However, if the location device is not in proximity, then access to that function is denied.

Although the invention has been described and illustrated in the above description and drawings, it is understood that this description is by way of example only and that numerous changes and modifications can be made by those skilled in the art without departing from the broad scope of the invention. Although the present invention finds particular use in portable cellular radiotelephones, the invention could be applied to any communication device, including pagers, electronic organizers, and computers. The present invention should be limited only by the following claims.

What is claimed is:

1. A method of locking a communication device based on proximity, the method comprising the steps of:
providing a location device operable to communicate with the communication device;
transmitting a signal by the location device;
detecting the signal by the communication device; and
locking at least one function of the communication device when the detecting step indicates that the location device is not in proximity to the communication device.

2. The method of claim 1, wherein the providing step includes the location device and communication device communicating over a short-range wireless link.

3. The method of claim 1, wherein the initializing step includes entering a unique identifier for the location device to control locking of the communication device.

4. The method of claim 1, wherein the initializing step includes a user selecting at least one function of the communication device for locking based on proximity.

5. The method of claim 1, wherein the detecting step includes measuring the strength of the signal by the communication device, and further comprising a step of comparing the strength to a threshold defining a proximity between the communication device and location device, and wherein the locking step includes locking the at least one function of the communication device when the signal strength falls below the threshold.

6. The method of claim 5, wherein the initializing step includes a user setting the signal strength threshold defining a proximity for triggering the locking step.

7. The method of claim 1, wherein the detecting step includes not receiving a signal by the communication device during a predetermined time.

8. The method of claim 1, wherein the locking step includes waiting a predetermined time, during which the signal indicates that the location device is not in proximity to the communication device, before locking the communication device.

9. The method of claim 8, wherein the initializing step includes setting the time before locking the at least one function of the communication device.

10. The method of claim 1, further comprising the step of indicating a locking message on the communication device when locked.

11. The method of claim 1, further comprising the step of prompting the user to enter an authorization code to access the at least one locked function of the communication device.

12. The method of claim 1, further comprising the step of unlocking the at least one function of the communication device when the detecting step indicates that the location device is within proximity to the communication device.

13. A method of locking a communication device based on proximity, the method comprising the steps of:
providing a location device with a unique identifier and operable to communicate with the communication device, the location device and communication device communicating over a short-range wireless link;
initializing the communication device and the location device, and selecting at least one function of the communication device for locking based on proximity;
transmitting a signal by the location device;
detecting the signal and unique identifier of the location device by the communication device; and
locking at least one function of the communication device when the unique identifier is identified and the detection step indicates that the location device is not in proximity to the communication device.

14. The method of claim 13, wherein the initializing step includes a user selecting outgoing calls, with the exception of emergency calls, for the at least one function of the communication device for locking based on proximity.

15. The method of claim 13, wherein the detecting step includes measuring the strength of the signal from the location device by the communication device, and comparing the strength to a threshold defining a proximity between the communication device and location device, and wherein the locking step includes locking the at least one function of the communication device when the signal strength falls below the threshold.

16. The method of claim 13, wherein the locking step includes waiting a predetermined time, during which the signal indicates that the location device is not in proximity to the communication device, before locking the communication device.

17. The method of claim 13, wherein the transmitting step includes periodically sending a polling signal to the location device, and the detecting step includes detecting whether the location device sends a signal responding to the poll within a predetermined number of polling attempts.

18. A proximity monitoring communication system for locking at least one function of a communication device, the system comprising:
a wireless location device operable on a short-range wireless network, the wireless location device including a unique identifier; and
a communication device operable on a wireless wide area network and the short-range wireless network to communicate with the location device,
a communication manager operable for detection of a signal from the location device to determine proximity thereof, wherein, when the communication manager detects that the location device is not in proximity to the communication device, the communication manager locks at least one function of the communication device.

19. The system of claim 18, wherein the communication manager locks outgoing calls from the communication device, with the exception of emergency calls.

20. The system of claim 18, wherein the communication manager compares a strength of the signal from the location device to a threshold, which defines a proximity between the communication device and location device, and the communication manager locks the at least one function of the communication device when the signal strength falls below the threshold.

21. The system of claim 18, wherein the communication manager waits a predetermined time, during which the signal indicates that the location device is not in proximity to the communication device, before locking the communication device.

22. The system of claim 18, wherein the communication manager directs the communication device periodically send a polling signal to the location device, and the communication manager detects whether the location device sends a signal responding to the poll within a predetermined number of polling attempts before locking the communication device.

23. The system of claim 18, wherein the communication manager compares Global Positioning System location information of the communication device and the location device, to define a proximity therebetween.

24. A method of locking a function of a communication device based on proximity, the method comprising the steps of:
providing a location device operable to communicate with the communication device;
selecting the function to lock on the communication device;
attempting to access the function on the communication device;
detecting the location device by the communication device; and
allowing access to the function when the detecting step indicates that the location device is in proximity to the communication device, and
denying access to the function when the detecting step indicates that the location device is not in proximity to the communication device.
